(19) United States
(12) Patent Application Publication
(10) Pub. No.: US 2005/0023897 A1
(43) Pub. Date: Feb. 3, 2005

(54) Method and apparatus for rebuilding track assembly

(76) Inventors: Peter W. Anderton, Peoria, IL (US); David G. Kupper, Edelstein, IL (US); Jerry A. Metz, Morton, IL (US)

Correspondence Address: CATERPILLAR INC.;100 N.E. ADAMS STREET, PATENT DEPT., PEORIA, IL, 616296490, US

(21) Appl. No.: 10/631,534

(22) Filed: Jul. 31, 2003

(51) Int. Cl. E05D 7/10

(52) U.S. Cl. 305/202

(57) ABSTRACT

A method and apparatus for rebuilding a track chain assembly is disclosed which restores the ability of the pin joint to retain lubricant to its original condition. The method includes disassembling the track chain assembly, reassembling the track chain assembly and sealing the radial surface of the track bushing at a location radially inward or radially outward from the original seal location. The apparatus includes a seal assembly with a seal portion moved either inward or outward from the original seal location.

### TECHNICAL FIELD

This invention relates generally to track chain assemblies for track-type work machines, and more particularly to a method and apparatus for rebuilding such track assemblies.

### BACKGROUND

Track chain assemblies are used to support and propel track-type work machines and are typically constructed from a plurality of articulately coupled link sections, which have a plurality of track shoes bolted thereto. The link sections have a plurality of pivot joints provided by pin and bushing connections. In addition to forming a portion of the pivot joint, the bushing is used as the drive connection of the track chain with the vehicle through engagement with the drive sprocket of the work machine. As a result of the driving engagement of the bushing with the sprocket and the repeated articulation between seals positioned adjacent the end faces of the bushing, at least two points of wear are formed. The first point of wear being the outer diameter of the bushing that engages the sprocket receives a high amount of wear, while the opposite side of the bushing is substantially free of wear. The other point of wear being the axial end faces of the bushings where the seals are pressed against, to retain lubricant. Grooves form on these end faces due to the repeated articulation.

In order to compensate for the one sided wear and to utilize the wear life available on the opposite, unworn side of the bushing, it has long been common practice to perform an operation, called “turning the bushings”. This term refers to the process of rotating the bushings relative to their respective links so as to expose the opposite, unworn side to the sprocket and to place the worn side away from the sprocket. The oldest and most common method of accomplishing the above bushing turn is through the complete disassembly of the track chain and then the reassembly of the chain with the bushings mounted in a new rotational position relative to their respective links. The process of disassembly causes a complete loss of the lubricant as well as causing the critical seals of the track to be disturbed. Newer methods leave the track assembled and rotate the bushing in place, such as the method disclosed in U.S. Pat. No. 4,554,720 issued on Nov. 16, 1985 and assigned to the owner of the present application. This method substantially reduces the labor involved and does not disturb the critical seals.

Additionally, it has long been a desire to improve the corrosion and abrasion characteristics of the end faces of track bushings. Many approaches have been developed for treating the track bushings to improve both corrosion and abrasion resistance. One such approach is described in U.S. Pat. No. 6,089,683 issued on Jul. 18, 2000 and assigned to the owner of the present invention. This method uses a laser cladding process to lay an abrasion and corrosion resistant material in a groove positioned in the bushing end face. Another approach is disclosed in U.S. Pat. No. 6,102,408 issued on Aug. 15, 2000 and assigned to the owner of he present application. In this method a corrosion and abrasion resistant ring is resiliently bonded to the bushing end face. Both of the above approaches have shown great improvements in retaining lubricant throughout the life of a track chain.

The present invention is directed toward overcoming one or more of the problems as set forth above.

### SUMMARY OF THE INVENTION

In one aspect of the present invention a method for rebuilding a track assembly is provided. The method includes disassembling a plurality of interconnected link sections of the track assembly; reassembling the plurality of interconnected link sections of the track assembly; sealing a plurality of track bushings at one of a radially inward and a radially outward seal portion away from an original seal location.

In another aspect of the present invention a rebuilt track assembly is provided. The rebuilt track assembly includes a plurality of interconnected link sections. Each link section has a left hand track link having an outboard end portion and an inboard end portion, a right hand link having an outboard end portion and an inboard end portion, a bushing having an outer peripheral surface, a pair of end faces and a bore concentric with the outer surface. The bushing is positioned in the inboard end portion of the left and right hand links. The rebuilt track assembly also includes a track pin having a first and a second end portion being positioned in the outboard end portion of the left and right hand link sections. The track pin is pivotally positioned in the bore of the bushing. A seal assembly is positioned in a counter bore of the outboard end portion of the left and right hand link section and makes sealing contact with the pair of end faces of the track bushing radially inward or radially outward from the original seal position.

In yet another aspect of the present invention a seal assembly for use with a rebuilt track assembly is provided. The track assembly includes a plurality of interconnected link sections with each link section including a left hand link, a right hand link, a track pin, and a bushing. The seal assembly includes a seal ring and a load member which are positioned in a counter bore of each of the left and right hand links. The load member is in biasing contact with the seal ring. The seal ring is adapted to contact the bushing at one of a radially inward and a radially outward seal portion away from an original seal position.

### BRIEF DESCRIPTION OF THE DRAWINGS

FIG. 1 is a fragmentary plan view of an exemplary track assembly (a portion of the track assembly is shown in a cross sectional view, for clarity of description);

FIG. 2 is an enlarged fragmentary view of the encircled portion of FIG. 1 and indicated 2; and

FIG. 3 is an enlarged fragmentary view of the encircled portion of FIG. 2 and indicated 3.

### DETAILED DESCRIPTION

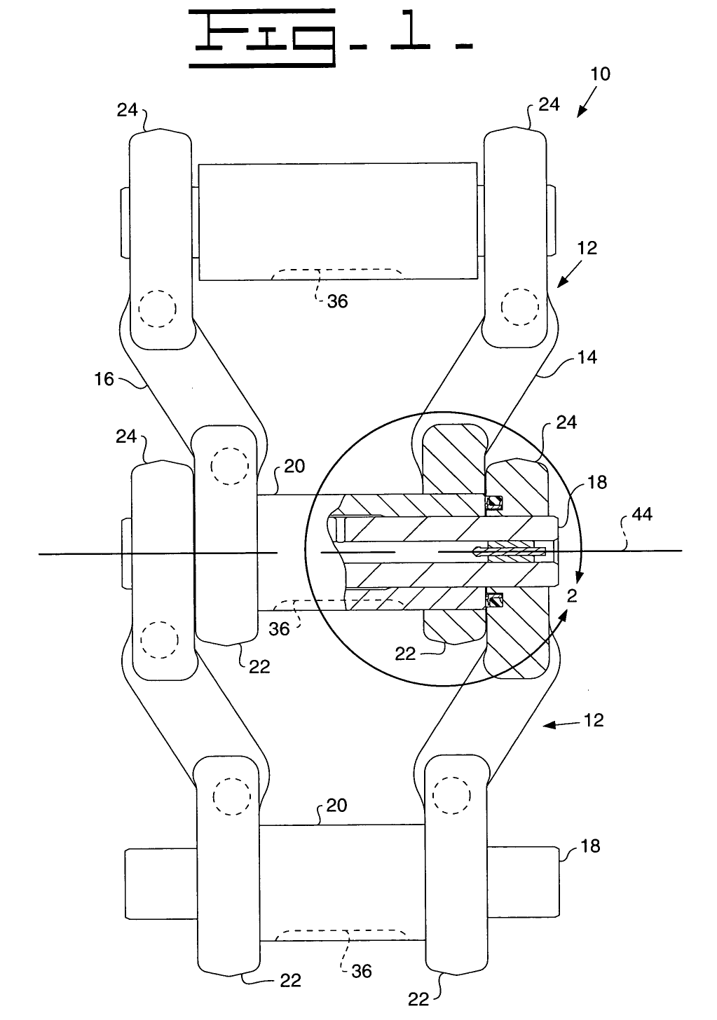

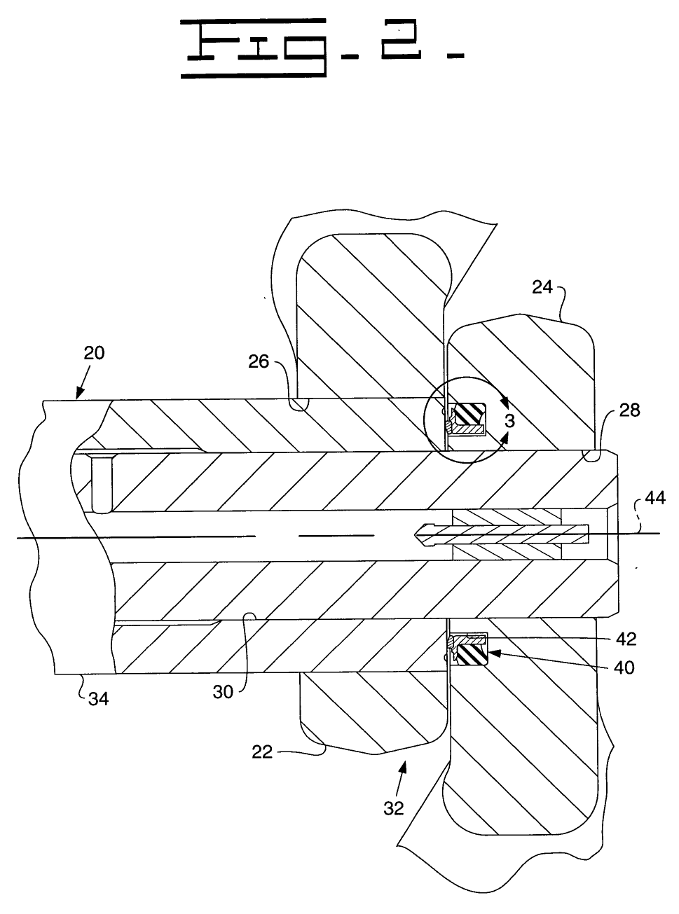

Referring now to the drawings and specifically to FIGS. 1 and 2, a portion of a track assembly 10 is shown. These track assemblies are used in a number of known track-type work machines (not shown) such as excavators, dozers, and the like. The track assembly 10 is constructed from a plurality of articulately coupled link sections 12. Each link section 12 includes a set of links, one being a left hand link 14 (the right link in FIG. 1) and the other being a right hand link 16 (the left link in FIG. 1), a pin 18, and a bushing 20. The pin 18 has a first and a second end portion 17,19. Each of the links 14,16 have opposite, laterally offsetting ends, an inboard end 22 and an outboard end 24. The offset allows the outboard end 24 of the links of one link section 12 to overlap the inboard ends 22 of the next succeeding link section.

The inboard ends 22 of the links 14,16 each have a larger bore 26 for receiving a respective end of the larger diameter bushing 20. The outboard ends 24 of the links 14,16 each have a smaller bore 28 for receiving a respective end of the smaller diameter pin 18. The ends of the pins 18 and the bushings 20 are secured into their respective bores 28,26 by means of a heavy press fit or other suitable means which is sufficiently great to secure and maintain the pins 18, bushings 20, and links 14,16 of each of the link sections 12 as a rigid, unitary member. The pin 18 of one link section 12 is pivotally received within a bore 30 of the bushing 20 of the adjoining link section 12 for providing a hinge joint 32 between the adjoining link sections 12.

The bushings 20 have an outer peripheral surface 34 that, in use, is drivingly engaged by the drive sprocket (not shown) of a track-type work machine (not shown). As the bushings 20 are maintained in a fixed angular relation to their respective link section 12, the drive sprocket only contacts a portion of the outer peripheral surface 34 of the bushing 20, causing a wear pattern 36 on one side of the outer peripheral surface 34 of the bushings 20. The wear pattern 36 is indicated in phantom in FIG. 1.

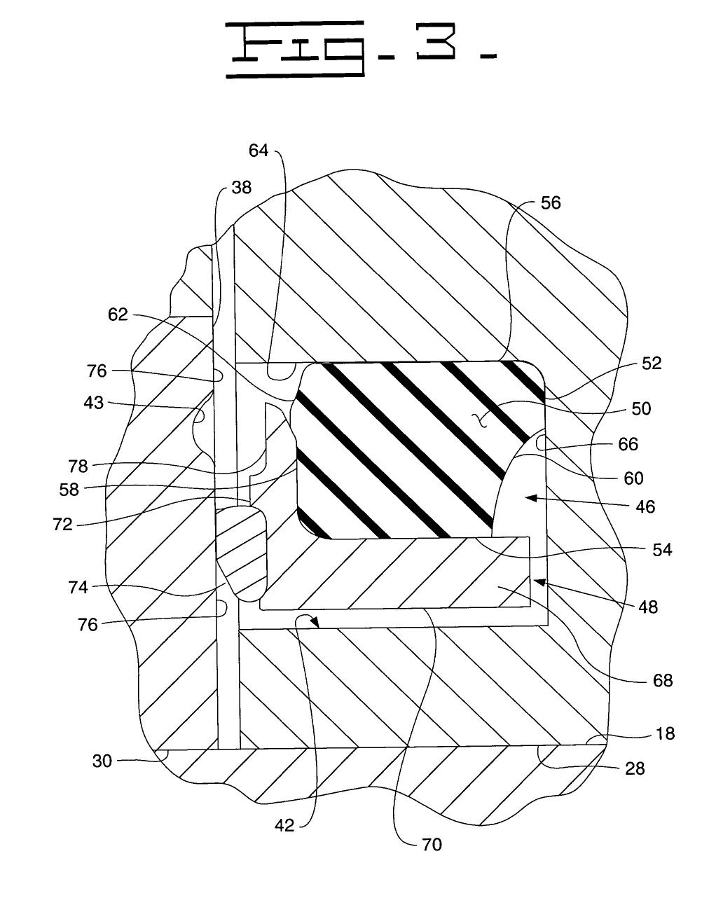

Referring now to FIGS. 2 and 3, each bushing 20 has a pair of end faces 38 (only one end is shown in FIGS. 2 and 3) with a seal assembly 40 in sealing contact therewith. The seal assembly 40 is disposed within a counter bore 42 positioned in the outboard end 24 of each link 14,16. Over time during normal operation a radial groove corresponding to an original seal location 43 is formed in the bushing end face 38, prior to the bushing turning operation, where the original seal assembly (not shown) makes contact with the bushing end face 38. The seal assembly 40 has a central axis 44, which is the pivot axis of adjoining link sections 12 as seen in FIGS. 1 and 2. Seal assembly 40 includes a load member 46 and a seal ring 48.

The load member 46 includes a body portion 50 made from any of a number of known resilient materials commonly used to manufacture seals such as elastomeric or rubber compounds, but it could be made from any of a number of materials or combinations thereof. The body portion 50 of the resilient load member 46 has a first radial portion 52 and a first linear peripheral portion 54. The first linear peripheral portion 54 is spaced from and extends generally parallel with the axis 44. The first radial portion 52 is generally perpendicular with the axis 44. The resilient load member 46 also includes a second linear peripheral portion 56 and a second radial portion 58. The second linear peripheral portion 56 is positioned on the opposite side of the body portion 50 and is spaced from first linear peripheral portion 54. The second radial portion 58 is positioned on the opposite side of the body portion 50 parallel to and spaced from the first radial portion 52. A first concave surface 60 is positioned between and joins the first radial portion 52 and the first linear peripheral portion 54. A second concave surface 62 is located on the opposite side of the body portion 50 spaced from the first concave surface 60 and is positioned between and joins the second linear peripheral portion 58 and the second radial portion 56. The first concave surface 60 generally has a larger radius than the second concave surface 62. The second radial portion 56 and the first linear peripheral portion 54 contact a sidewall 64 and a bottom 66, respectively of the counter bore 42 of the inboard end portion 22.

Seal ring 48 has a body portion 68. Body portion 68 has a first leg 70 that extends along the first linear peripheral portion 54 of the resilient load member 46 and a second leg portion 72 that extends along the second radial portion 58. A seal portion 74 is positioned on the second leg 72 of the seal ring 48 parallel to and spaced from the second radial portion 58 of the resilient load member 46. Seal portion 74 contacts a radial surface 76 of the bushing end face 38 that is shown as being radially inward from the radial groove 43. However, it should be understood that the seal portion 74 might be configured to contact the radial surface 76 radially outward from the radial groove 43 and still retain the desired function. The second leg 72 of the seal ring 48 also includes a debris relief portion 78 adjacent to the seal portion 74 and opposed to the radial groove 43. Debris relief portion 78 is a reduced width in the second leg 72 radially outward from the central axis 44. In the embodiment shown the seal portion 74 of the seal ring 48 is manufactured from a polycarbonate material and the body portion 68 is manufactured from a polyurethane material. Other suitable materials may be used for the seal portion 74 and the body portion 68 of the seal ring 48 and still retain the functional attributes as described herein.

### INDUSTRIAL APPLICABILITY

During normal operation of a track-type work machine at least two locations of wear occur in components of the track assembly 10. The first wear location occurs on the outer surface 34 of the track bushing 20 at the point where the sprocket makes contact therewith forming the wear pattern 36. The other location is at the original seal location 43 at the intersection of the bushing end face 38 and the seal ring 48 of the seal assembly 40. When these wear points reach a predetermined level of wear or the hours of use reach a predetermined limit, based on the specific working environment, the track assembly 10 can be rebuilt.

The rebuild process for the current track assembly 10 is performed by first disassembling adjoining link sections 12 from one another. This is done by pressing the track pin 18 from the bore 28 from the outboard end 24 of both left and right hand links 14,16. The bushings 20 are then pressed from the bore 26 of the inboard end 22 of the left and right track links 14,16. The original seal assembly (not shown) is then removed from the counter bore 42 of the outboard end 24 of the links 14,16 and discarded. A new seal assembly 40 is placed in the counter bore 42. Each bushing 20 is then turned to expose an unworn side to the sprocket (not shown) and position the wear pattern 36 in a position so as to not make contact with the sprocket. The bushings 20 are then pressed back into the bore 26 of the inboard end 22 of each link 14,16. The adjoining link sections 12 are rejoined by pressing the track pins 18 back through the bore 28 of the outboard end 24 of one link 14,16 through the bore 30 of the bushing 20 and into the bore 28 of the other link 14,16.

The seal assembly 40 makes sealing contact with the radial surface 76 of the pair of end faces 38 of each bushing 20 at a location radially away from the radial groove/original seal location 43. In the example shown in the FIGS. 2 and 3, the position of the seal portion 74 of the seal assembly 40 is radially inward from the groove 43 however it should be understood that radially outward would work as well. With the seal assembly 40 contacting a location away from the original seal location 43, the sealing effectiveness is brought back to the original condition. That is, not only is the bushing 20 turned so that the sprocket engages an unworn portion of the outer surface 34 but also the sealing effectiveness between the pair of end faces 38 and the seal portion 74 of the seal assembly 40 is restored to the original production condition. Additionally, the debris relief portion 78 of the seal ring 48 allows for material to be alleviated therefrom. Any debris build up is eliminated from the debris relief portion 78 due to the increased area provided between the pair of end faces 38 and the seal assembly 40 during the repeated articulation there between.

1. A method for rebuilding a track assembly, the track assembly including plurality of interconnected link sections, each link section having a left hand, a right hand link, a bushing and a track pin, the method comprising:
disassembling the plurality of interconnected link sections of the track assembly;
reassembling the plurality of interconnected link sections of the track assembly; and
sealing a radial surface of a pair of end faces of each track bushing at one of a radially inward and a radially outward seal portion away from an original seal location.

2. The method of claim 1, including pressing the track pin from adjacent link sections, to disconnect adjacent link sections.

3. The method of claim 2, including pressing the bushing from the left hand and the right hand link of each link section.

4. The method of claim 3, including rotating the track bushing of each link section to expose an unworn portion of an outer peripheral surface thereof.

5. The method of claim 4, including replacing a seal assembly positioned in a counter bore in an outboard end portion of the left and the right hand link of each link section.

6. A rebuilt track assembly comprising:
a plurality of interconnected link sections, each link section having;
a left hand link having an outboard end portion and an inboard end portion;
a right hand link having an outboard end portion and an inboard end portion;
a bushing having an outer peripheral surface, a pair of end faces and a bore concentric with the outer surface, said bushing positioned in the inboard end portion of the left and right hand links;
a track pin having a first and a second end portion, the first and second end portions being positioned in the outboard end portion of said left and right hand links, said track pin being pivotally positioned in the bore of said bushing; and
a seal assembly being positioned in a counter bore of the outboard end portion of the left and right hand link and making sealing contact with the pair of end faces of said bushing at one of a radially inward and a radially outward seal portion from an original seal location.

7. The rebuilt track assembly of claim 6 wherein said bushing of each of said plurality of interconnected link sections is rotated to expose an unworn surface of an outer peripheral surface.

8. The rebuilt track assembly of claim 6 wherein said seal assembly includes a load member and a seal ring.

9. The rebuilt track assembly of claim 6 wherein said seal ring includes a debris relief portion.

10. A seal assembly for use with a rebuilt track assembly, said track assembly including a plurality of interconnected link sections, each link section including a left hand link, a right hand link, a track pin, and a bushing, said seal assembly comprising:
a seal ring;
a load member positioned in a counter bore of each of the left and right hand links, said load member being in biasing contact with said seal ring; and
said seal ring adapted to contact the bushing at one of a radially inward and a radially outward seal portion away from an original seal location.

11. The seal assembly of claim 10, wherein said seal ring includes a body portion and a seal portion.

12. The seal assembly of claim 11, wherein said body portion includes a first leg portion and a second leg portion, said seal portion is positioned on said second leg portion.

13. The seal assembly of claim 11, wherein said second leg portion includes a debris relief portion positioned adjacent said seal portion.
